(19) United States
(12) Patent Application Publication
(10) Pub. No.: US 2011/0271202 A1
(43) Pub. Date: Nov. 3, 2011

(54) NOTIFICATIONS FOR MULTIPLE POINTS OF PRESENCE

(75) Inventors: Dudley Wong, Sunnyvale, CA (US); David Feldman, San Francisco, CA (US)

(73) Assignee: Yahoo!, Inc., Sunnyvale, CA (US)

(21) Appl. No.: 12/772,096

(22) Filed: Apr. 30, 2010

(51) Int. Cl. G06F 3/01; G06F 15/16

(52) U.S. Cl. 715/752

(57) ABSTRACT

A server application for an instant messaging service opens a first connection with a first client application executing on a device, after receiving a login from the first client application. Next the server application opens a second connection with a second client application, after receiving the same login from the second client application. Then the server application receives an instant message associated with the login and determines whether the first client application is in a network idle state following a period of idle time. If the first client application is in the network idle state, the server application causes a notification as to the receipt of the instant message to be displayed on a user interface for the second client application. The displayed notification might also be accompanied by an aural notification or a haptic alert.

### RELATED APPLICATION

This application is related to U.S. patent application Ser. No. ______ (YAHOP098) entitled “State Transfer for Instant Messaging System with Multiple Points of Presence”, filed contemporaneously with this application. The disclosure of that application is hereby incorporated herein by reference.

### BACKGROUND

Instant messaging systems allow for real-time or near real-time communication using textual instant messages made up of packets that conform to an instant messaging protocol, such as the open Extensible Messaging and Presence Protocol (XMPP nee Jabber) and the proprietary protocols, Yahoo! Messenger (YMSG) developed by Yahoo!, Open System for Communication in Realtime (OSCAR) developed by AOL, and Microsoft Notification Protocol (MSNP) developed by Microsoft.

Most instant messaging systems make use of presence information that reports a user's willingness (e.g., do not disturb, busy and inactive, busy, etc.) and availability (e.g., away, inactive, available, etc.) to communicate. Ordinarily, a user's presence is associated with an endpoint such as a personal computer or a mobile device (e.g., a smartphone), which supports a client application based on an instant messaging protocol supported by an instant messaging service. So, for example, right after a user opens and signs onto such a client application, a server application for the instant messaging service will record the user's status as willing and available to communicate and broadcast this status to any other open interested client applications (e.g., those associated with a user's contact list, friend list, buddy list, etc.). Then later, if there is a lack of user-related activity at the device associated with the client application, the client application will report this lack of activity to the corresponding server application and the server application will record and broadcast the user's status as inactive.

Many instant messaging systems support multiple points of presence (MPOP). In some MPOP systems, a user can simultaneously open and sign onto multiple client applications at multiple endpoints. When an instant message is received by a server application in such a system, there are various design alternatives for transmitting the instant message to the user at the multiple open endpoints. The simplest approach is to simply transmit the instant message to all of them. However, such an approach results in a duplication of instant messages that the typical user regards as annoying and/or confusing.

### SUMMARY

In an example embodiment, a computer-implemented method is described for providing notifications in an instant messaging system that supports multiple points of presence. According to the method, a server application for an instant messaging service opens a first connection with a first client application executing on a device, after receiving a login from the first client application. Next the server application opens a second connection with a second client application, after receiving the same login from the second client application. Then the server application receives an instant message associated with the login and determines whether the first client application is in a network idle state following a period of idle time. If the first client application is in the network idle state, the server application causes a notification as to the receipt of the instant message to be displayed on a user interface for the second client application. The displayed notification might also be accompanied by an aural notification or a haptic alert.

In a second example embodiment, an apparatus is described, namely, a computer-readable storage medium which persistently stores an executable program that is part of a server application for an instant messaging service. According to the executable program, the server application opens a first connection with a first client application executing on a device, after receiving a login from the first client application. Next the server application opens a second connection with a second client application, after receiving the same login from the second client application. Then the server application receives an instant message associated with the login and determines whether the first client application is in a network idle state following a period of idle time. If the first client application is in the network idle state, the server application causes a notification as to the receipt of the instant message to be displayed on a user interface for the second client application. The displayed notification might also be accompanied by an aural notification or a haptic alert.

Other aspects and advantages of the invention will become apparent from the following detailed description, taken in conjunction with the accompanying drawings, which illustrates by way of example the principles of the invention.

### BRIEF DESCRIPTION OF THE DRAWINGS

FIG. 1 is a simplified network diagram for an instant messaging system, in accordance with an example embodiment.

FIG. 2A is a flowchart diagram showing a process for transferring state between two client applications for instant messaging associated with the same user, in accordance with an example embodiment.

FIGS. 2B to 2D show user interfaces for a use case in which a user travels from home to work without signing out of a client application, in accordance with an example embodiment.

FIG. 3A is a flowchart diagram showing a process for transferring state between two client applications for instant messaging associated with the same user where one of the client applications is running on a mobile device, in accordance with an example embodiment.

FIG. 3B is a sequence diagram showing a use case for transferring state between two client applications for instant messaging associated with the same user where one of the client applications is running on a mobile device, in accordance with an example embodiment.

FIG. 4A is a flowchart diagram showing a process for conditionally transferring state between two client applications for instant messaging associated with the same user where both client applications are running on the same device, in accordance with an example embodiment.

FIGS. 4B to 4D show user interfaces for a use case for conditionally transferring state between two client applications for instant messaging associated with the same user where both client applications are running on the same device, in accordance with an example embodiment.

FIG. 5A is a flowchart diagram showing a process for causing a client application for instant messaging executing on a mobile device to display a notification, in accordance with an example embodiment.

### DETAILED DESCRIPTION

In the following description, numerous specific details are set forth in order to provide a thorough understanding of the exemplary embodiments. However, it will be apparent to one skilled in the art that the example embodiments may be practiced without some of these specific details. In other instances, process operations and implementation details have not been described in detail, if already well known.

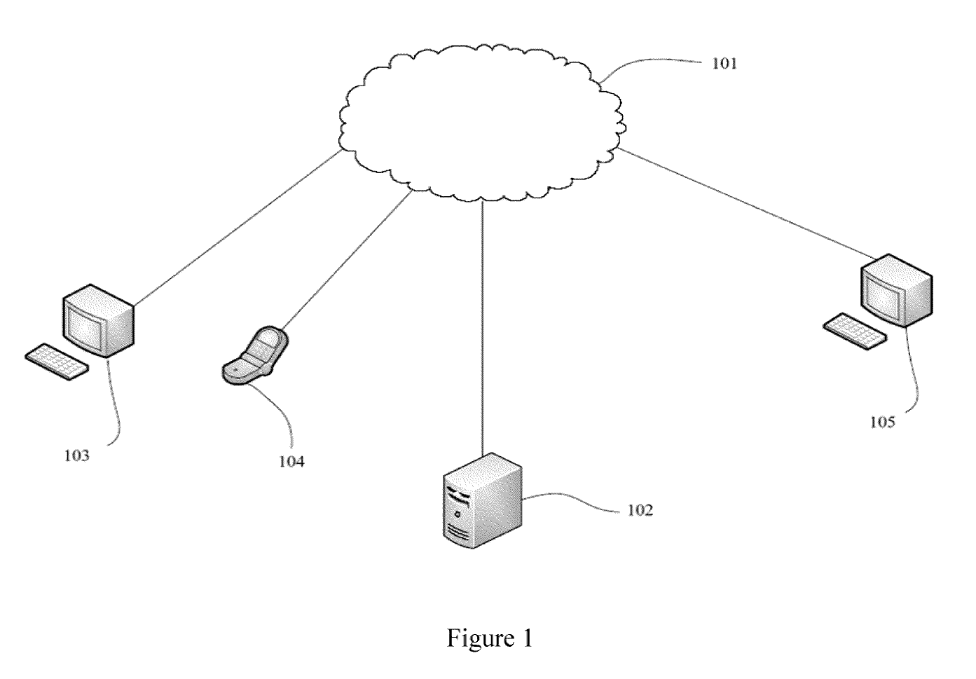

FIG. 1 is a simplified network diagram for an instant messaging system, in accordance with an example embodiment. As depicted in this figure, a personal computer 103 (which might be a laptop or other mobile computer) associated with a user and a mobile device (e.g., a standard cell phone or a smartphone such as an iPhone, Blackberry, Android, etc.) 104 associated with the same user are connected by a network 101, e.g., a local area network (LAN), a wide area network (WAN) including the Internet, etc., with a server 102. Server 102 might be one of many servers in a distributed system of servers, e.g., in a data center supported by a storage area network (SAN). Also connected to the network is another personal computer 105 (which might be a laptop or other mobile computer) associated with another user. A client application that includes functionality for transmitting instant messages according to an instant messaging protocol executes on the personal computer 103, the personal computer 105, and the mobile device 104.

In an example embodiment, this client application might be a client application associated with a particular instant-messaging service that supports a particular instant-messaging protocol, such as Yahoo! Messenger or AOL Instant Messenger^{SM}. Alternatively, the client application might be a third-party client application, such as Pidgin or Trillian, which supports connection to a number of instant-messaging services. It will be appreciated that this client application might be browser-based, either on the personal computers 103 and 105 or on the mobile device 104 (e.g., a “clientless platform” for mobile instant messaging). In an alternative example embodiment, the client application on mobile device 104 might be an embedded client. Also, in an example embodiment, server 102 is running a server application associated with a particular instant-messaging service that supports (or accepts) a particular instant-messaging protocol. However, in an alternative example embodiment (e.g., involving XMPP), the server application running on server 102 might support (or accept) multiple instant-messaging protocols, which might or might not be interoperable.

In an example embodiment, personal computers 103 and 105 and server 102 might include (1) hardware consisting of one or more microprocessors (e.g., from the x86 family), volatile memory (e.g., RAM), and persistent storage (e.g., a hard disk or network access to a SAN) and (2) an operating system (e.g., Windows, Mac OS, Linux, Windows Server, Mac OS Server, etc.) that runs on the hardware. Similarly, in an example embodiment, mobile device 104 might include (1) hardware consisting of one or more microprocessors (e.g., from the ARM family), volatile memory (e.g., RAM), and persistent storage (e.g., flash memory such as microSD) and (2) an operating system (e.g., Symbian OS, RIM BlackBerry OS, iPhone OS, Palm webOS, Windows Mobile, Android, Linux, etc.) that runs on the hardware.

For purposes of this disclosure, a mobile device can be defined as any device which is expected to move about with a user and which maintains, during such movement, a connection with an instant messaging service. It will be appreciated that this definition is broad enough to include a laptop computer with an external display and support for wide-area wireless data in accordance with the 3G (3rd Generation) family of standards for mobile telecommunication promulgated by the International Telecommunication Union. Of course, such a laptop computer might include (1) hardware consisting of one or more microprocessors (e.g., from the x86 family), volatile memory (e.g., RAM), and persistent storage (e.g., a hard disk) and (2) an operating system (e.g., Windows, Mac OS, Linux, etc.) that runs on the hardware.

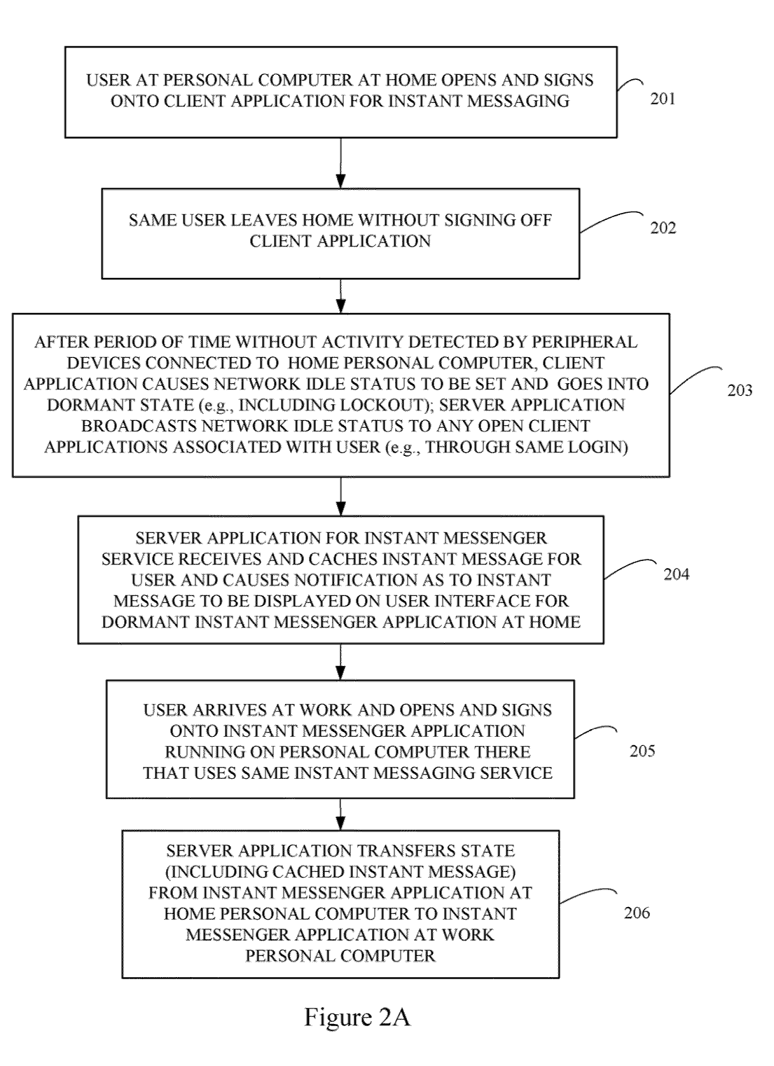

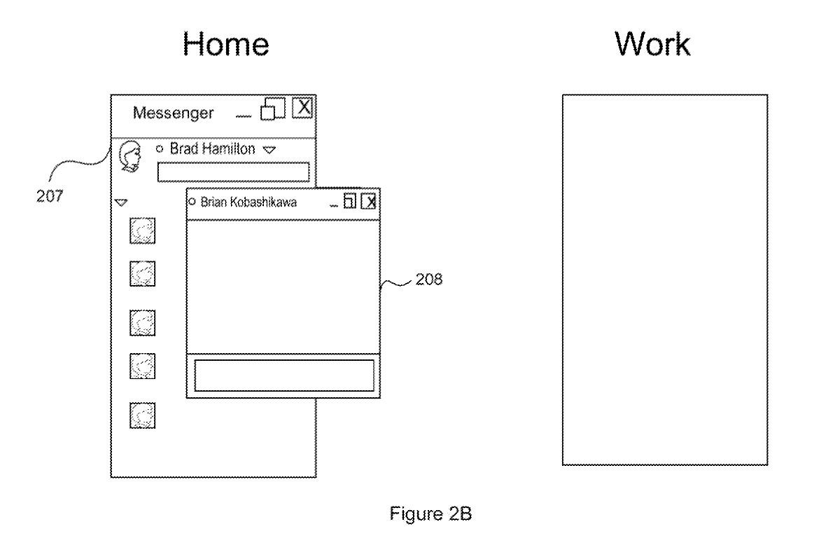

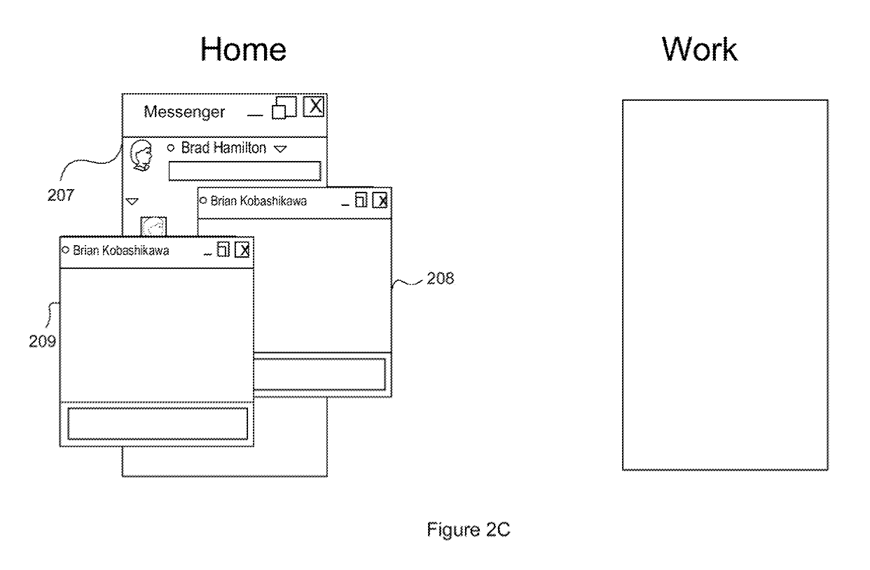

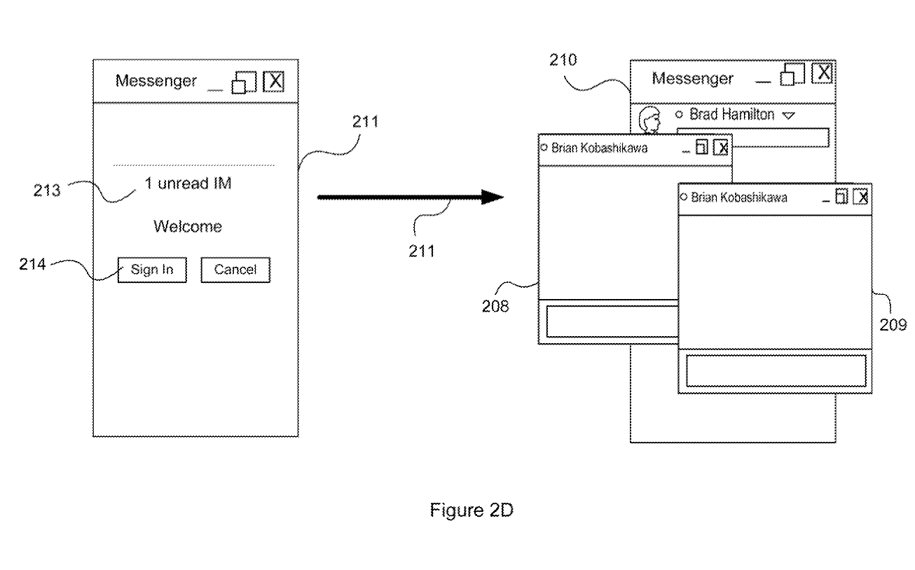

FIG. 2A is a flowchart diagram showing a process for transferring state between two client applications for instant messaging associated with the same user, in accordance with an example embodiment. In operation 201 of the process, a user at a personal computer in the user's home opens and signs onto a client application for instant messaging, for example, a client application for Yahoo! Messenger or AOL Instant Messenger^{SM}. In operation 202 of the process, the user leaves home without signing off of the client application. After a period of time without activity detected by the peripheral devices connected to the home personal computer, the client application running on the personal computer (1) reports a network-idle status to the server application for the instant-messaging service and (2) goes into a dormant state which might include locking the user out of the client application, in operation 203 of the process. It will be appreciated that once the user is locked out of the client application, the user will have to sign back into the client application to access its user interface. It will also be appreciated that such lockout helps protect the privacy of the user's conversation. Also, in operation 203, the server application for the instant-messaging service broadcasts the client application's network-idle status to any open client applications associated with the same user, e.g., through the same login.

In operation 204, the server application receives and caches an instant message for the user and causes a notification as to the instant message to be displayed on the user interface for the dormant instant messenger application at the home personal computer. Here it will be appreciated that the instant message could be cached (e.g., in memory buffers backed by disk storage) by the server application running on the server or could be cached by the client application running on the personal computer. Then in operation 205, the user arrives at work and opens and signs onto a client application running on a personal computer there that uses the same instant messaging service as the client application running on the personal computer at home. In operation 206, the server application transfers state (including the cached instant message) from the instant messenger application running on the home personal computer to the instant messenger application running on the work personal computer.

As noted above, in operation 203, the client application causes a network-idle status to be set after a period of time without activity being detected by peripheral devices connected to the home personal computer. The length of this time period might be (1) matched to the length of the time period used to determine inactive (or idle) status with respect to user availability at the client application as reported to client applications associated with contacts and/or (2) configurable by the user at the client application. The peripheral devices that might be used to detect inactivity include a keyboard, mouse, Webcam, a microphone, a Bluetooth headset, etc. In an example embodiment, network-idle status is a Boolean value that is recorded or stored by the server application for an instant-messaging service.

Also, in operation 203, the server application for the instant-messaging service broadcasts the network-idle status to any open client applications associated with the same user, e.g., through the same login. Upon receipt of the network-idle status for the dormant client application, an open client application might request a change to its notification level or update how it displays notifications.

As noted above, in operation 206, the server application for the instant-messaging service transfers state from the client application running on the home personal computer to the client application running on the work personal computer. Such state will include the instant message that was received and cached by the server application. Additionally, state might include: (1) other instant messages that were received and sent earlier at the home computer in the same conversation, in order to provide context for the instant message that was received and cached by the server application; (2) visible notifications such as add requests, sticky toasts, etc., that the user would have seen on the home client application if the user had not left home; (3) availability (e.g., presence) and status messages; (4) window positions (relative or approximate) in the user interface for the home application, if similar windows are supported by the user interface for the work client application; (5) window configurations (e.g., which conversations are tabbed together, per-conversation skin settings, etc.) in the user interface for the home application, if similar windows are supported by the user interface for the work client application; and (6) in-session display options (e.g., display images shown/hidden, timestamps shown/hidden, message history shown/hidden, etc.).

FIGS. 2B to 2D show user interfaces for a use case in which a user travels from home to work without signing out of a client application, in accordance with an example embodiment. In the first FIG. 2B of this use case, a user is at home using a client application for instant messaging on a personal computer. In the example depicted, the client application is for the Yahoo! Messenger instant-messaging service, although this example is not meant to be limiting. Any other similar client application and instant-messaging service might have been used instead. The user interface for the client application includes an application view 207 which has dropdown menus that allow a user to perform such tasks as initiating and terminating conversations with a contact, managing contacts, etc. Since the user is presently involved in a conversation, the user interface also includes a conversation view 208, which has dropdown menus and a window that supports such tasks as textual editing of an instant message, transmission of the instant message, and displaying a received instant message which is part of the conversation.

FIG. 2C depicts the next event in the use case. Shortly after the user leaves home to work without signing out of the client application, the user receives an instant message which is displayed in conversation view 209. The instant message is part of the same conversation associated with conversation view 208. FIG. 2D depicts the next two events in the use case. After a period of time during which no activity is detected by the peripheral devices at the home personal computer, the client application causes a network-idle status to be set and goes into a dormant state that includes locking the user out of the client application. This is shown by the dormant view 211, which replaces the application view 207 in the user interface at the home personal computer. The dormant view 211 includes a notification 213 as to the instant message that was displayed in conversation view 209 while the user was in transit to work. The dormant view 211 also includes a button 214 labeled “Sign in” that a user could click on to sign onto the client application and recover from a state of being locked out. However, in an alternative embodiment, the client application might not explicitly require the user to sign in to recover from a state of being locked out. And in such an embodiment, the dormant view 211 might not include a “Sign in” button.

The final event in the use case occurs when the user arrives at work, turns on a personal computer there, and signs onto a client application running which uses the same instant messaging service as the client application running on the user's home personal computer. The user's login results in an application view 210, which is similar to application view 207 described above. The login also results in a transfer of state 211 that results in the display of conversation views 208 and 209 on the user's personal computer at work. It will be appreciated that the user has not seen any instant messages displayed in conversation view 209. And it will be appreciated that any instant messages displayed in conversation view 208, which the user has seen, provide context for any instant messages displayed in conversation view 209.

In FIG. 2D, dormant view 211 is juxtaposed with application view 210 and conversation views 208 and 209. However, state transfer might occur before the client application causes a network-idle status to be set. That is to say, state transfer is triggered by the user's login onto the client application running on the personal computer at the user's work. State transfer does not depend on the setting of a network-idle status by the client application running on the personal computer at the user's home.

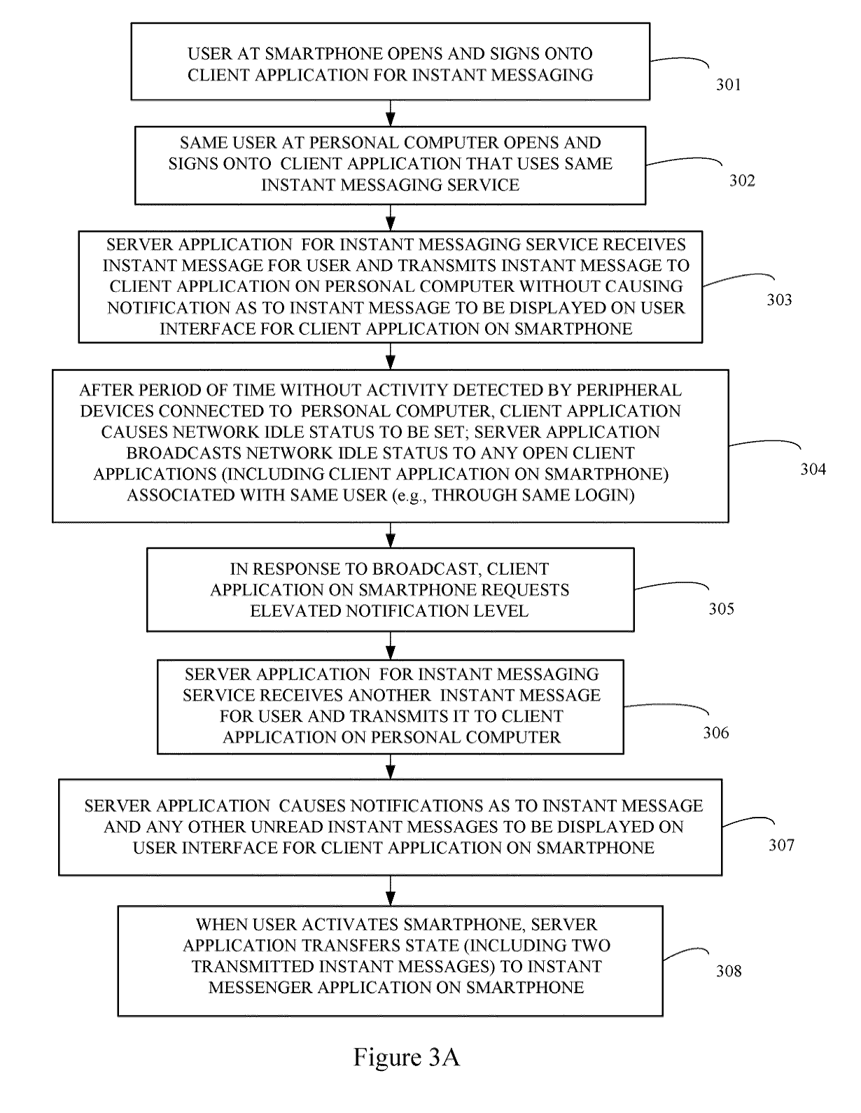

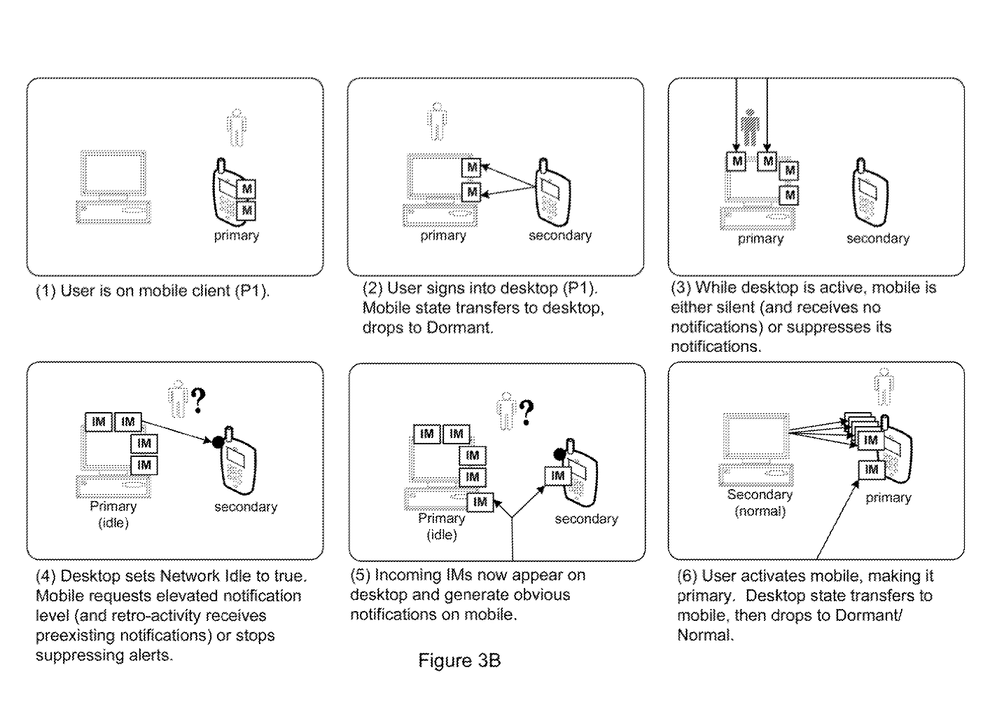

FIG. 3A is a flowchart diagram showing a process for transferring state between two client applications for instant messaging associated with the same user where one of the client applications is running on a mobile device, in accordance with an example embodiment. In operation 301 of the process, a user at a smartphone opens and signs onto a client application for instant messaging, for example, a client application for Yahoo! Messenger. In operation 302 of the process, the same user at a personal computer opens and signs onto a client application for instant messaging that uses the same instant messaging service. In operation 303, the server application for the instant messaging service receives an instant message for the user and transmits the instant message to the client application running on the personal computer, without causing a notification as to the instant message to be displayed on the user interface for the client application running on the smartphone. It will be appreciated that such a notification would probably be annoying. After a period of time without activity detected by the peripheral devices connected to the personal computer, the client application running on the personal computer reports a network-idle status to the server application for the instant-messaging service, in operation 304 of the process. It will be appreciated that the client application running on the personal computer does not go into a dormant state that includes locking out the user, since the user might still be in the vicinity of the personal computer, e.g. talking on the smartphone. Also, in operation 304, the server application for the instant-messaging service broadcasts the client application's network-idle status to any open client applications associated with the same user, e.g., through the same login, including the client application running on the smartphone. In response to the broadcast, the client application running on the smartphone requests an elevated notification level from the server application, in operation 305 of the process. In operation 306, the server application receives another instant message for the user and transmits it to the client application running on the personal computer. Then in operation 307 of the process, the server application causes a notification as to the instant message and any other unread instant messages to be displayed on the user interface for the client application on the smartphone. For purposes of this operation, an unread instant message might include any message received at some point (e.g., in the range of 0 to 10 minutes) after the client application has set a network-idle status or received after notice of activity detected by a peripheral device connected to the personal computer. Alternatively, an unread instant message might include any instant message associated with a conversation view (e.g., window) that has not been activated or otherwise been the subject of input from a peripheral device, such as a mouse or keyboard, connected to the personal computer.

When the user activates the smartphone in operation 308 of the process, the server application transfers state (including the two transmitted instant messages) from the instant messenger application running on the home personal computer to the instant messenger application running on the work personal computer. It will be appreciated that the two transmitted instant messages include one that was presumably read and one that was unread. The instant message that was presumably read provides context for the unread instant message. Here too, state might also include the other items described above, e.g. window position and configuration, if the user interface on the smartphone supports such items.

Here again, state transfer in operation 308 is triggered by the user's activation of the smartphone. State transfer does not depend on the setting of a network-idle status by the client application running on the personal computer at the user's personal computer in operation 304 or on operations 305, 306, and 307.

FIG. 3B is a sequence diagram showing a use case for transferring state between two client applications for instant messaging associated with the same user where one of the client applications is running on a mobile device, in accordance with an example embodiment. In the first event (1) of the use case, a user (depicted as a human shape) is signed onto a client application for instant messaging running on a mobile device, which is the user's primary client application (P1) at this point in time. The user receives two instant messages (M) from the instant-messaging service which are displayed by the user interface for the client application running on the mobile device. In the second event (2) of the use case, the user goes to a desktop computer and signs onto a client application that uses the same instant-messaging service. At that point in time, the client application on the desktop computer becomes the user's primary client application (P1) and the client application running on the mobile device becomes a secondary client application. It will be appreciated that the terms “primary” and “secondary” are terms used in co-owned, published U.S. patent application Ser. No. 11/840,184, filed on Aug. 16, 2007, entitled “Multiple Points of Presence in Real Time Communications”, which is incorporated herein by reference. The server application for the instant-messaging service transfers state (including the two instant messages M) to the primary client application, i.e., the client application on the desktop computer, which displays the messages in a user interface. After a period time without activity being detected by the client application running on the mobile device, that client application becomes dormant and sets a network-idle status with the server application, which it then broadcasts to any other open client applications associated with the user, including the client application running on the desktop computer.

In the third event (3) of the use case, the client application running on the desktop computer receives two more instant messages (M) and displays them in the user interface for the client application. At this point in time, the client application running on the mobile device receives no notifications since it is in a silent state and any notifications might be annoying to the user. Alternatively, the mobile device suppresses its notifications, e.g., at the command the user. In the fourth event (4) of the use case, the client application running on the desktop computer sets its network-idle status, following a period without activity being detected by the peripheral devices connected to the desktop computer. The server application for the instant-messaging service broadcasts the network-idle status to any open client applications associated with the user, including the client application running on the mobile device. The client application running on the mobile device requests an elevated notification level from the server application, which then transmits to that client application the notifications that were previously withheld. Alternatively, the mobile device stops suppressing notifications. It will be appreciated that the user's activities are unknown at this time.

In the fifth event (5) of the use case, the user's activities remain unknown. When the server application receives an incoming instant message (IM) for the user, the server application transmits the instant message to the client application running on the desktop computer for display in a user interface. Also at this point in time, the server application will cause the client application running on the mobile device to display a notification as to the instant message. In the sixth event (6) of the use case shown in FIG. 3B, the user activates the mobile device making its client application the primary client application. The server application transfers state (including all of the instant messages in the conversation) from the client application running on the desktop computer to the client application running on the mobile device. Then the server application causes the client application running on the desktop computer to go into a dormant state.

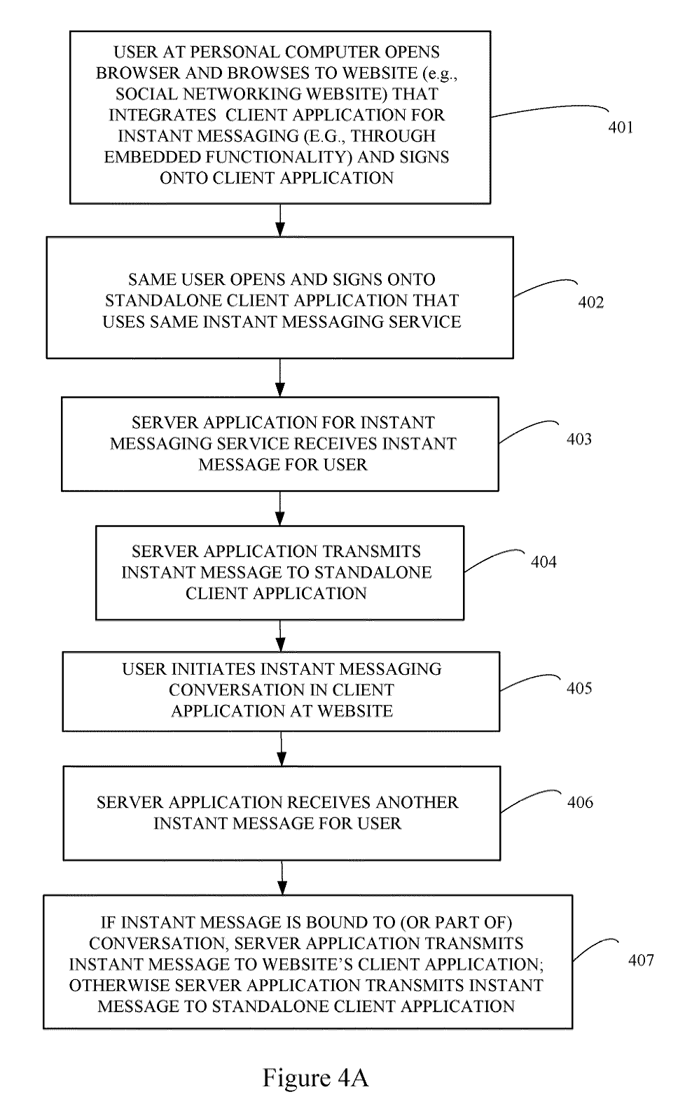

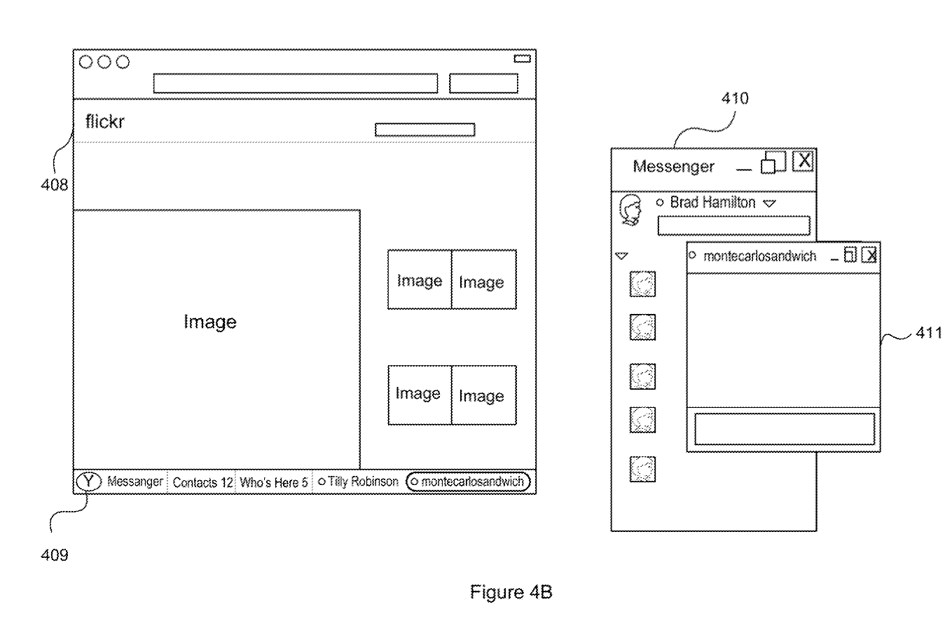

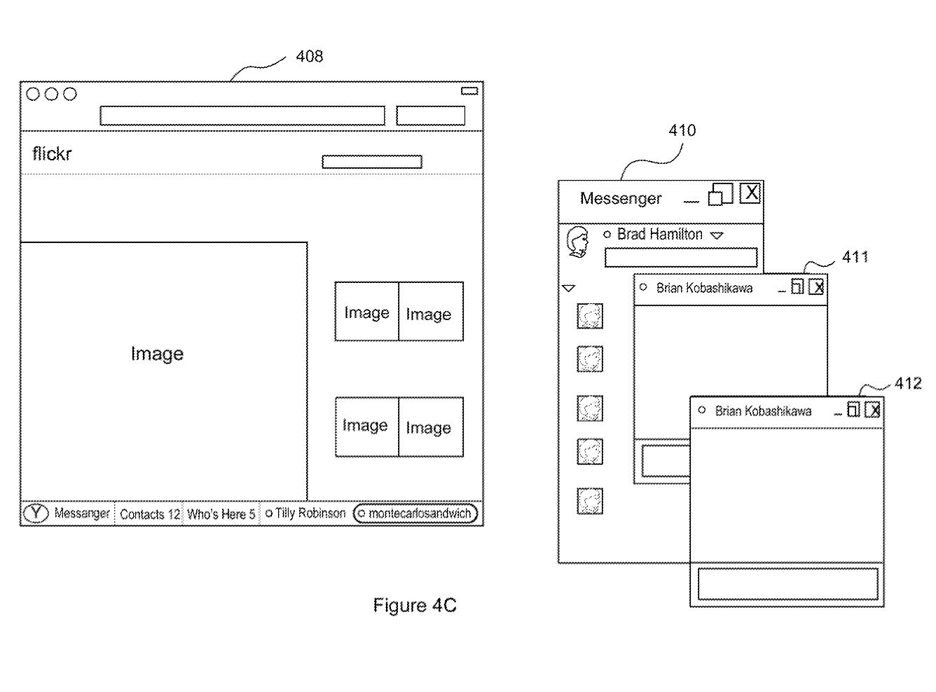

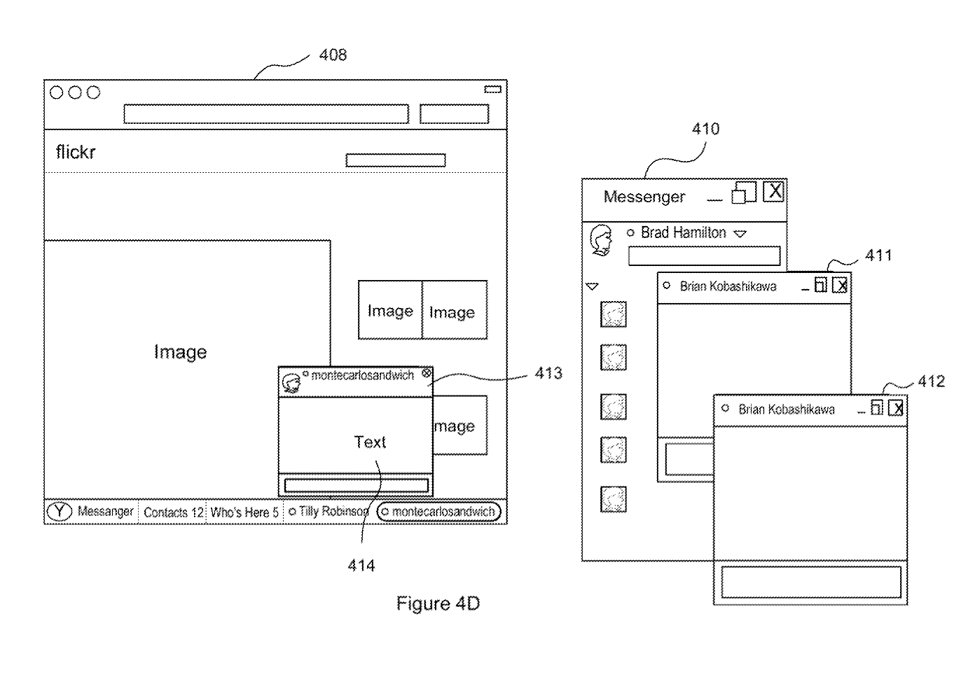

FIG. 4A is a flowchart diagram showing a process for conditionally transferring state between two client applications for instant messaging associated with the same user where both client applications are running on the same device, in accordance with an example embodiment. In operation 401 of the process, a user at a personal computer (1) opens a browser and browses to a website (e.g., a social networking website) that integrates a client application for instant messaging (e.g., through embedded functionality) and (2) signs onto the client application there. In operation 402, the same user opens and signs onto a standalone client application that uses the same instant messaging service and that runs on the same personal computer. In operation 403, the server application for the instant messaging service receives an instant message for the user. The server application transmits the instant message to the standalone client application, in operation 404. Then in operation 405, the user initiates an instant messaging conversation in the client application at the website. In operation 406, the server application receives another instant message for the user. If the instant message is bound to (or part of) the conversation initiated in the client application at the website (e.g., as indicated by supplemental data in the instant message's header), the server application transmits the instant message to the website's client application, in operation 407. Otherwise, the server application transmits the instant message to the standalone client application.

FIGS. 4B to 4D show user interfaces for a use case for conditionally transferring state between two client applications for instant messaging associated with the same user where both client applications are running on the same device, in accordance with an example embodiment. In the first FIG. 4B of this use case, a user at a personal computer has opened a browser and browsed to a website 408 (e.g., Yahoo!'s flickr®) that has an embedded client application 409 for instant messaging. In the example depicted, the embedded client application is for the Yahoo! Messenger instant-messaging service, although this example is not meant to be limiting. Any other similar client application and instant-messaging service might have been used instead.

Also, as depicted in FIG. 4B, the user has opened and signed onto a standalone client application for instant messaging on the same personal computer. Again, the standalone client application is Yahoo! Messenger, which, of course, uses the same instant messaging service as the client application embedded in the website. The user interface for the standalone client application includes an application view 410 which has dropdown menus that allow a user to perform such tasks as initiating and terminating conversations with a contact, managing contacts, etc. Since the user is presently involved in a conversation, the user interface also includes a conversation view 411, which has dropdown menus and a window that supports such tasks as textual editing of an instant message, transmission of the instant message, and displaying a received instant message which is part of the conversation.

FIG. 4C depicts the next event in the use case, namely, the receipt of an instant message for the user by the server application for the instant messaging service. The server application transmits the instant message to the standalone client application, where the instant message is displayed in conversation view 412. FIG. 4D depicts the last event in the use case. The user has now initiated a conversation in the embedded client application at the website 408, as evidenced by the conversation view 413. When the server application receives an instant message for the user, the server application transmits it to the embedded client application which displays the instant message as text 414 in conversation view 413. It will be appreciated that the server application regards the instant message as being bound to (or part of) the conversation in the embedded client application, e.g., as indicated by supplemental data in the instant message's header.

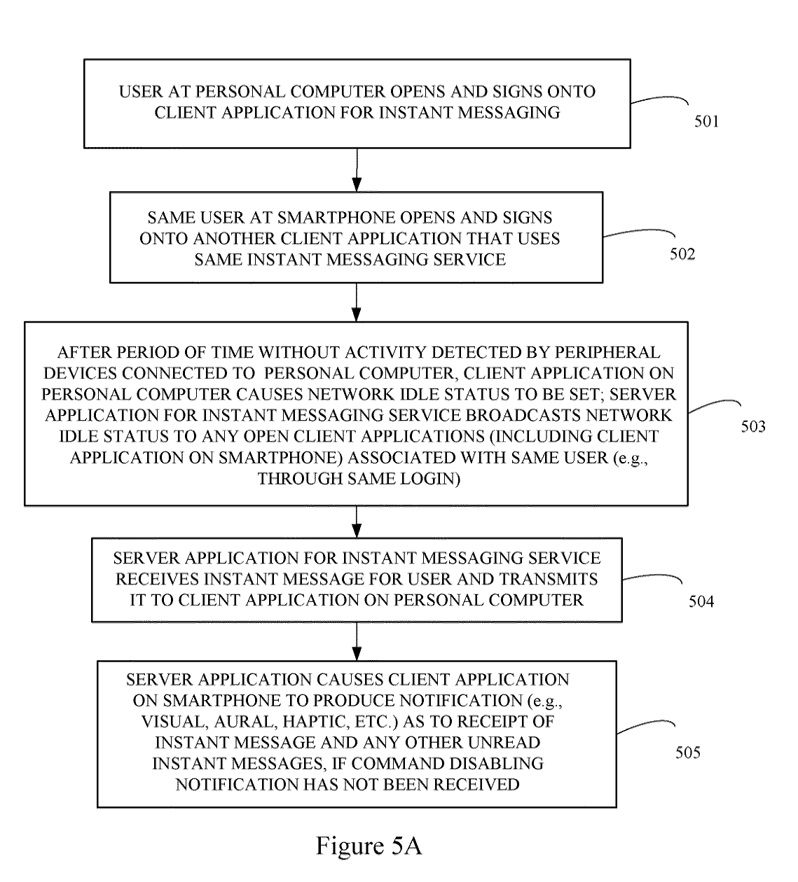

FIG. 5A is a flowchart diagram showing a process for causing a client application for instant messaging executing on a mobile device to display a notification, in accordance with an example embodiment. In operation 501 of the process, a user at a personal computer opens and signs onto a client application for instant messaging, for example, a client application for Yahoo! Messenger. In operation 502 of the process, the same user at a smartphone opens and signs onto a client application for instant messaging that uses the same instant messaging service. After a period of time without activity detected by the peripheral devices connected to the personal computer, the client application running on the personal computer reports a network-idle status to the server application for the instant-messaging service, in operation 503 of the process. Also, in operation 503, the server application for the instant-messaging service broadcasts the client application's network-idle status to any open client applications associated with the same user, e.g., through the same login, including the client application running on the smartphone. It will be appreciated that client application running on the personal computer does not go into a dormant state that includes locking out the user, since the user might still be in the vicinity of the personal computer, e.g., talking on the smartphone. In operation 504, the server application for the instant messaging service receives an instant message for the user and transmits it to the client application running on the personal computer. Then in operation 505, the server application causes the client application on the smartphone to produce a notification (e.g., visual, aural, haptic, etc.) as to receipt of the instant message and any other unread instant messages, if a command disabling notification has not been received from the user. It will be recalled that other unread instant messages might include any message received at some point (e.g., in the range of 0 to 10 minutes) after the client application has set a network-idle status or received after notice of activity detected by a peripheral device connected to the personal computer. Alternatively, an unread instant message might include any instant message associated with a conversation view (e.g., window) that has not been activated or otherwise been the subject of input from a peripheral device, such as a mouse or keyboard, connected to the personal computer.

In an example embodiment, the client application running on the mobile device might support a user's command that (1) disables notifications for a specified period, (2) disables notifications indefinitely, and/or (3) disables notifications until logoff from the client application running on the mobile device.

The invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the carrier network discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion.

Although example embodiments of the invention have been described in some detail for purposes of clarity of understanding, it will be apparent that certain changes and modifications can be practiced within the scope of the following claims. For example, the utility toolbar might be implemented as a browser toolbar add-on rather than as part of the platform itself. Accordingly, the present embodiments are to be considered as illustrative and not restrictive, and the invention is not to be limited to the details given herein, but may be modified within the scope and equivalents of the following claims. In the following claims, elements and/or steps do not imply any particular order of operation, unless explicitly stated in the claims or implicitly required by the specification and/or drawings.

What is claimed is:

1. A method for managing multiple connections, comprising:
opening a first connection with a first client application executing on a first device, wherein the opening of the first connection includes receiving from the first client application a login and wherein the first client application enables communication over a network in accordance with an accepted instant messaging protocol;
opening a second connection with a second client application executing on a second device that is mobile, wherein the opening of the second connection includes receiving from the second client application the same login and wherein the second client application enables communication over a network in accordance with an accepted instant messaging protocol;
receiving an instant message associated with the login;
determining whether the first client application is in a network idle state following a period of idle time; and
causing a notification as to the receipt of the instant message to be displayed on a user interface for the second client application, if the first client application is in the network idle state, wherein each operation of the method is executed by a processor.

2. The method of claim 1, wherein the instant message is an unread instant message.

3. The method of claim 2, wherein an instant message is unread if the instant message was received during the period of idle time on the first device and not displayed by the second device.

4. The method of claim 1, wherein idle time depends on detection of activity at the first device.

5. The method of claim 4, wherein detection of activity is performed by a peripheral device associated with the first device.

6. The method of claim 1, wherein a mobile device maintains, during transit, the second connection and a user interface associated with the second connection.

7. The method of claim 1, wherein the network idle state is accompanied by a locking out of the first client application.

8. The method of claim 1, wherein the notification is not displayed if a command disabling notifications has been received from the second client application.

9. The method of claim 8, wherein the command is selected from the group consisting of commands that disable notifications for a specified period, commands that disable notifications indefinitely, and commands that disable notifications until logoff from the second client application.

10. The method of claim 1, wherein the display of the notification is accompanied by an aural alert.

11. The method of claim 1, wherein the display of the notification is accompanied by a haptic alert.

12. A computer-readable storage medium with an executable program stored thereon, wherein the program instructs a processor to perform the following operations:
open a first connection with a first client application executing on a first device, wherein the opening of the first connection includes receiving from the first client application a login and wherein the first client application enables communication over a network in accordance with an accepted instant messaging protocol;
open a second connection with a second client application executing on a second device that is mobile, wherein the opening of the second connection includes receiving from the second client application the same login and wherein the second client application enables communication over a network in accordance with an accepted instant messaging protocol;
receive an instant message associated with the login;
determine whether the first client application is in a network idle state following a period of idle time; and
cause a notification as to the receipt of the instant message to be displayed on a user interface for the second client application, if the first client application is in the network idle state.

13. The computer-readable storage medium of claim 12, wherein the instant message is an unread instant message.

14. The computer-readable storage medium of claim 13, wherein an instant message is unread if the instant message was received during the period of idle time on the first device and not displayed by the second device.

15. The computer-readable storage medium of claim 12, wherein idle time depends on detection of activity at the first device.

16. The computer-readable storage medium of claim 15, wherein detection of activity is performed by a peripheral device associated with the first device.

17. The computer-readable storage medium of claim 12, wherein the mobile device is a device that maintains, during transit, the second connection and a user interface associated with the second connection.

18. The computer-readable storage medium of claim 1, wherein the network idle state is accompanied by a locking out the first client application.

19. The computer-readable storage medium of claim 1, wherein the notification is not displayed if a command disabling notifications has been received from the second client application.

20. A method for managing multiple connections, comprising:
opening a first connection with a first client application executing on a first device, wherein the opening of the first connection includes receiving from the first client application a login and wherein the first client application enables communication over a network in accordance with an accepted instant messaging protocol;
opening a second connection with a second client application that is mobile, wherein the opening of the second connection includes receiving from the second client application the same login and wherein the second client application enables communication over a network in accordance with an accepted instant messaging protocol;
receiving an instant message which is associated with the login;
conditionally causing a notification as to the instant message to be displayed by the second client application, wherein the condition is based at least in part on detection of activity at the first device and wherein each operation of the method is executed by a processor.
